(19) United States
(12) Patent Application Publication
(10) Pub. No.: US 2014/0279134 A1
(43) Pub. Date: Sep. 18, 2014

(54) Method and system for extending participation in an online auction to a winning bidder

(71) Applicants: Anthony L. Fontaine, Henderson, NV (US); Michael Staw, Westport, CT (US)

(72) Inventors: Anthony L. Fontaine, Henderson, NV (US); Michael Staw, Westport, CT (US)

(21) Appl. No.: 13/815,696

(22) Filed: Mar. 14, 2013

(51) Int. Cl. G06Q 30/08

(52) U.S. Cl. CPC G06Q 30/08
USPC 705/26.3

(57) ABSTRACT

The invention is a secondary exchange system attached to an online auction system which provides winners with the ability to extend their play. The online auction system facilitates the sale of goods and services through an auction which offers bidders the potential for purchasing goods and services at huge discounts from retail pricing. The invention enables winning bidders to optionally exchange their purchase for alternative items or credits towards future auctions. This provides the participant a validation for the purchase of the initial item, the option of exchanging for an item of greater perceived personal value, or the means to extend their play and enjoy the excitement of the experience without additional cost.

### FIELD OF INVENTION

This invention relates to the field of electronic commerce and more particularly, to online auctions in which winning bidders can extend play or receive an exchange of equal or more value, thus to increase enjoyment of auction participation.

### BACKGROUND OF THE INVENTION

Auctions conducted online are well known. Generally auctions are conducted so that participant bidders bid on an item and the highest bidder wins. While a winning bidder can exalt in his winning, the winning bidder must stop his or her play after he has won. This in turn limits the entertainment value offered by on-line auctions to winning bidders. Various on-line auctions seek to increase enjoyment for the losing bidder, but there has been no attention paid to the winning bidder and his or her enjoyment.

By way of background, to provide losing bidders more enjoyment a twist on an auction is an entertainment auction, which sometimes is referred to as a penny auction. In a penny auction, participant bidders must buy a bundle of bids and use one every time they raise their virtual paddle. In some configurations, bids cost 60 cents to $1 each and are bought in packs of 10 to 700, depending on the site. In the case of penny auctions enjoyment is extended by the number of inexpensive bids.

As an entertainment medium, offering extended play and additional entertainment options is important to unsuccessful bidders to prolong the experience, thereby providing greater value to the consumer.

Existing Prior art teaches the wisdom of offering multiple methods which may enhance the entertainment experience by extending play by offering incentives for participation. In U.S. Pat. No. 7,461,022 incentive points can be earned in a variety of actions taken by users and later used in the bidding process. The user may be rewarded for viewing an advertisement or providing additional information about themselves or signing up for a service.

This type of shopping is truly an entertainment experience. Therefore a great deal of effort is employed to mitigate or ease the negative experience of not winning an auction. For losing bidders in US Patent Applications 20120173309 and 20120233011 the losing users are may be provided with discounts and other incentives in relation to the value of unsuccessful bids placed. These incentives may take the form of a stored value to be used with an auction sponsor. Receiving some residual from an unsuccessful auction encourages continued participation.

In U.S. Pat. No. 8,027,880 the bidder may opt to abandon the bidding process, but still purchase the item at a reduced retail price to avoid the remorse associated with an unsuccessful bidding strategy. In this patent, the bidder utilizes the value of the bids they have placed and applies that value as the discount from the retail price of the item.

Competition among bidders increases the excitement of the experience as each bidder formulates a strategy for winning the auction. From the above, all of the above references extend play for a losing bidder. On the other hand, US Patent Application 20120278197 teaches that a person who wins an auction may re-auction their item. However, this makes them a seller, at which point the bidder then can no longer play. This is because the auction has been completed and his role as player has ended.

### SUMMARY OF THE INVENTION

The present invention relates to providing successful bidders in an online auction with extended play options or an option to an exchange. This permits the player extra auction play or to receive an exchange item of greater or equal perceived value, or both.

In one embodiment, at the time of purchase of the item that is won, the participant is offered additional options for exchange and extended play. Customer history and preferences are stored and a software exchange logic module determines items to be offered for exchange based upon customer preferences as they relate to the specific item to be exchanged. The items offered for exchange may take the form of a replacement item that may have a higher perceived value by the participant, as determined by their individual preferences, or points/credits that may be used in future auctions. Alternatively, a mystery item or any combination of items may be offered.

Greater choices at the end of a winning experience serve to enhance the experience by instilling a degree of anticipation in the participant to discover what option they may be offered. For example, a participant may knowingly bid on an item even though the item is not entirely desirable with the knowledge that at the end of the process the item may be substituted for a more desirable item or the opportunity to receive credits for future play. Offering a mystery item whose exchange may trigger additional options may provide additional interest to players, especially if after the selection of a mystery item the participant is again offered options for exchange and extended play. The decision of when to accept an item for exchange, extend play, or continue to discover mystery items makes the subject on-line auction more appealing. Play continues until the player has either accepted an exchange, opted for extended play or retains the original item. This process adds an additional degree of fascination and mystery to the online auction experience. Even the most experienced in the art of online auction systems will appreciate the application of customer preferences and customer history used in combination with the subject logic that provides not only an experience of greater value to the customer, but higher margins to the operator

### BRIEF DESCRIPTION OF THE DRAWINGS

These and other features of the subject invention will be better understood in connection with the Detailed Description, in conjunction with the Drawings, of which:

FIG. 1 is a block diagram of the secondary exchange system and components as connected to an online auction system;

FIG. 2 is a block diagram of the internal components of the secondary exchange system of FIG. 1 and the communications flow within the secondary exchange system and the online auction system of FIG. 1;

FIG. 3 is a block diagram of the internal components of the secondary exchange system and the communications flow between the communications module and the online auction system of FIG. 1;

FIG. 4 is a block diagram detailing the database activity, offer creation, and exchange logic, and data flow between the primary or secondary exchange logic, the offer creation logic and the exchange database module of the system of FIG. 1; and,

FIG. 5 is a simplified block diagram example of a preferred embodiment of the subject Invention.

### DETAILED DESCRIPTION

Referring now to FIG. 1, the drawings depict the secondary exchange system and components when taken in combination form an apparatus, or secondary exchange system (SEC) connected to an Online Auction System (OAS) 6 capable of independent operation for the purpose of determining player exchange opportunities based upon player history and preferences. Note throughout the drawings, the terms Customer and Player may be used interchangeably in meaning.

As shown in FIG. 1, the subject unique provides the operator with the ability to increase its margin by appealing to existing, or anticipated customer values. In one embodiment the customer will receive a known high value product and have twice as much bidding power for future products. The net result is that the operator, through a unique combination and utilization of soft costs, can increase its margin significantly when extending play or offering an exchange.

As to the secondary exchange system and components, the block diagram of FIG. 1 provides an overview of the manner in which the apparatus is connected to the OAS 6 and how it communicates to the player 2. The player 2 is connected via the Internet 4 to the OAS 6. In addition to the logic and operational capabilities of the OAS 6 for the display and tracking of bids, the OAS 6 nominally contains a product database 8 and a customer or player database 10. A communications interface 11 provides a channel of communications with a secondary exchange system (SEC) 12. This communications channel may be directly connected via any of a number of commonly available communications mediums and protocols such as web services of XML. These various communications protocols may be configured in the communications module 14 allowing customization of the secondary exchange system 12 for use with any number of OAS 6 types. The secondary exchange system 12 is made up of 5 Modules; a communications module 14, an exchange logic module 16, the UI presentation module 18, administration module 28, and an exchange database module 20 which consists of a customer database 22 and a product database 24. An administration module 28 provides the interface for the configuration and operation of each of these components by a secondary exchange system administrator managing the secondary exchange system 12 via an input display 26. Input display 26 communicates to SEC 12 via any number of commonly available communications mediums and protocols as determined by the producer of the secondary exchange system 12. The operation components in combination will be described more fully in the following drawings.

Referring now to FIG. 2, the secondary exchange system 12 and communications module 14 data flow is as follows. The block diagram of FIG. 2 gives greater insight to the role of the communications module 14 to govern and route requests and fulfillment between the OAS 6 and the rest of the components of the secondary exchange system 12. As previously described, the player 2 is connected via the Internet 4 to the OAS 6. For illustration purposes the communication channel 11 between OAS 6 and the SEC 12 described in FIG. 1 has been omitted to focus on the information exchange between the two systems, rather than the protocol of the exchange.

Upon the conclusion of any auction, the OAS 6 passes player auction data to the communications module 14 which first analyzes the data 32 to determine if the result of the player's auction attempt was successful. If upon conclusion of the auction, the auction information 32 returned a “No” value 34, the player was not successful, the update exchange history 36 in the communications module 14 sends the updated information to an exchange logic module 16. The exchange logic module 16 then accesses the exchange database module 20 as will be described.

If the auction result was successful, “Yes” 40, communications module 14 passes the auction information to the exchange logic module 16. Greater detail as to the nature of the information passed will be discussed hereafter. The exchange logic module 16 then queries the exchange database module 20 to determine customer history and preferences as stored in the customer database 22 for the best exchange opportunity to present. The exchange logic module 16 then queries the product database 24 for availability. This process continues until a suitable exchange has been identified. The exchange logic module 16 then requests the UI presentation module 18 for proper page layout and formatting as required by the OAS 6. Upon receipt of the formatted page, the exchange logic module 16 passes the page to communications module 14 for transmission to the OAS 6. The formatted exchange offer 46 is communicated 48 to the OAS 6 for display. Player input for the exchange 50 from OAS 6 is received and communications module 14 determines the proper routing of the information.

If the player input for the exchange is accepted “Yes”, 52 the update exchange history query 54 of the communications module 14 updates 56 the OAS 6 and relays the information 59 to the exchange logic module 16, which in turn relays the information to the exchange database module 20 which then updates both the customer database 22 and the product database 24. If the exchange is not accepted a “No” condition at 57 triggers the request new exchange function 58 of the communications module 14 to request another exchange opportunity from exchange logic module 16. The exchange logic module 16 informs the exchange database module 20 to update the customer database 22 with the declined exchange, then query the exchange database module 20 for a new exchange opportunity. Upon receiving the new exchange opportunity the system proceeds to update OAS 6 and eventual display by the results.

The exchange process continues until either an exchange has been accepted as shown at 52 or until the exchange logic module 16 determines that there are no other appropriate exchanges available. If there are no appropriate exchanges available, an exchange condition occurs where the player choice is limited to simply receiving the originally purchased item. The secondary exchange system 12 treats this as a “like exchange” for player preference and database tracking purposes. In this condition, the exchange logic module 16 recognizes the like exchange and UI presentation module 18 sends an appropriately formatted page informing the player that there are no other exchanges available, with appropriate messaging as determined by the OAS 6 operator.

Referring to FIG. 3 and the secondary exchange system 12 and exchange logic module 16 data flow, this block diagram further explores the components of the SEC 12. While the interaction between the communications module 14, the UI presentation module 18 and an exchange database module 20 are depicted, the diagram is intended to provide greater detail on the functions of the exchange logic module 16. The previous diagram has provided detail regarding the function of the communications module 14 when used in combination of the components of the apparatus, the following diagrams will provide further granularity into the functioning of the combined subsystems to provide the unique capabilities of the secondary exchange system 12.

With the OAS 6 as the previously described initiator of requests, and recipient of services from the secondary exchange system 12, the communications link 60 conveys player 2 information regarding auction results and ensuing exchange information. A messaging protocol 62 between the communications module 14 and the exchange logic module 16 transmits the initial auction data 64. If this is a winning bid, it will include the product 104. Within the exchange logic module 16, offer creation logic 66 governs the processing of the exchange. Routines within offer creation logic 66 act in concert to determine exchange opportunities through interaction with exchange database module 20. Upon entry into the offer creation logic 66 the determination is made if this is the players first exchange request 68. As described in FIG. 2 this may be either a successful bid, FIG. 2 at 40, or an unsuccessful bid, FIG. 2 at 34. Regardless of the outcome of the players auction attempt (successful or unsuccessful), if this is the first exchange opportunity a “Yes” condition 70 is recorded, and a new customer exchange history setup function 72 is executed. The customer exchange history setup function 72 creates customer number and populates customer database 22 records accordingly. The customer number may be the same as is used in OAS 6, or a unique identifier assigned by the customer exchange history setup 72. Once completed, the new customer data 75 is stored in the customer database 22 and passed within the offer creation logic 66 of the exchange logic module 16 for processing.

If this is not the first exchange opportunity a “No” condition is posted at 76 and the data continues within the offer creation logic 66 of the exchange logic module 16 bypassing the customer exchange history setup 72, as there is no requirement to create a new customer record. Initial exchange opportunities are determined by the primary exchange logic 80 function within the offer creation logic 66. The primary exchange logic 80 executes queries 82 to both the customer database 22 and the product database 24 in order to determine the exchange offer 88. The exchange offer 88 may consist of one or more products 90 depending on the operator's guidelines. In this example 90 may represent multiple different exchange product options, but are shown as 90 to simplify the exchange process since an unknown number of exchange options may be identified. Upon exchange offer determination, the offer creation logic 66 will flag the product 90 as being unavailable until final exchange determination. The product is essentially in a holding pattern. The offer creation logic 66 must also ensure that the offer is available as illustrated at 92.

Since product database 24 tracks availability of products, it may return an exchange offer with a “No” condition for availability 94. As previously described, if there are no Exchange Offers available, the exchange offer is processed as a like exchange. Essentially a like exchange is processed in the same way as an offer accepted 96 with a “Yes” condition 98 passed to the offer fulfillment logic 100. Routines within the offer fulfillment logic 100 will now pass the final exchange information 102 to exchange database module 20 to update the appropriate records in the customer database 22 and the product database 24. It will decrement the inventory for the quantity of Product 90 that was flagged in the accepted exchange while incrementing the quantity of the Product 104 that was the item in the original winning bid. The product 104 had been taken out of inventory following the winning bid, and now must be returned due to the exchange. With all customer and product records updated, offer fulfillment logic 100 now transmits on 106 the exchange acceptance 108 to communications module 14 where it will be routed on 110 to the UI presentation module 18 for page layout and formatting where, upon completion it will be returned to communications module 14 for transmission to OAS 6 where it will be communicated over the Internet 4 to the player 2.

In this instance, the exchange cycle is complete. The main accounting systems on the OAS 6 are updated and the OAS fulfillment process is implemented. This is the basic process that is followed upon any acceptance of an exchange offer, or the lack of availability for subsequent exchange offers.

If during the offer availability routine 92 the exchange offer is available, a “Yes” condition 114 is recognized, the exchange offer is transmitted on line 116 to communications module 14, formatted by UI presentation module 18 and finally communicated to OAS 6 for display as previously depicted. The player 2 is then offered a choice between one or more exchange opportunities. If the player accepts an opportunity, the transmission from communication module 14 to the exchange logic module 16 flows into offer creation logic 66 via a route 118 associated directly with offer acceptance 96. The offer acceptance will now be processed by the offer creation logic 66.

If the player does not accept the exchange opportunity, that condition is routed to the offer acceptance logic 96 with a “No” condition 120 where The secondary exchange logic 122 executes queries consistent with the process followed by primary exchange logic 80, but including the new information regarding the declined exchange at 124. The product database 24 is updated to show the return to inventory of the current product 104. Exchange histories are updated in both the customer database 22 and the product database 24 in order to determine the exchange offer 136 and a new item 90 for exchange is selected. secondary exchange logic 122 then routes the offer to the offer availability routine 92 where the availability will decide on the processing attributes previously described for a “Yes” 114 or “No” 94 condition. The process continues until the player either accepts an exchange, or until there are no further exchanges available. In this diagram, the process continues as current product 104 is offered for exchange with exchange product 90 in an iterative fashion until either 90, or 104 is selected, or there is no 90 to display.

Referring now to FIG. 4 as to offer creation logic 66 flow for determining exchanges, this block diagram offers additional perspective to the query functions and process of the offer creation logic 66 within the exchange logic module 16 of FIG. 3; and provides a simplistic view of possible database elements which may be contained in a customer database 22 and the product database 24 and components of the exchange database module 20. For illustration purposes, the offer creation logic 66 is shown between the two Database components to simplify the interchange of query, fulfillment and update functions.

Database requests 178 are initiated by either the primary 80 or secondary exchange logic programs 122 of the exchange logic module 16 as depicted in FIG. 3, and fulfilled by routines within the offer creation logic 66 program, FIG. 4. All requests contain either a number passed through the system by the OAS 6, or a unique identifier generated by the secondary exchange system 12. A routine 68 determines whether this is the 1st exchange request (ie whether the customer exists in the customer database 22) with an initial “Yes” flag 182 that prompts customer history setup 72 programs to query customer database 22 for an existing record. If the Record does not exist, it will signal the SEC 12 to query the OAS 6 for customer information 73. If the OAS 6 has a record then the setup customer history populates those records in the customer database 22, if the OAS 6 has no exchange record, the customer setup programs 72 initiates a record entry, then synchronizes the main OAS database 10 with the customer database 22 for all records associated with the identifier originally provided. The customer setup program 72 then populates the customer database 22 with as much information as obtainable and returns the records to the 1st exchange request program 68 where a “No” flag 186 is set. At this point the process continues along the same course as if this was not the first exchange requested by a player 2.

The offer creation logic 66 programs will now access customer history 82 to query customer database 22. Using the customer identifier 192 the program will analyze customer history 194 for previous bid information 196, previous successful bid information 198 and previous exchange information 200. For Illustration and simplicity, database fields have been limited to depict the minimum data required for the preferred embodiment of the invention.

In this figure previous bid information 196 includes:

Product ID 202 which is a unique identifier for each product;
Number of attempts 204 which refers to how many auctions this player has bid for this product ID 202. Although not depicted, information flow for losing previous bids is also maintained to make the offer creation logic 66 more effective.

Moreover, number of bids/auction 206 refers to the average number of bids placed for each auction for this product ID 202 and bid frequency value 208 is a value indicating the player's interest in the product ID 202. It is a value assigned by taking the number of attempts and bids overall to determine how often the player bids on a particular product ID and how many bids they will place in each auction.

Next the offer creation logic 66 program will analyze the previous successful bid information 198 including product ID 210 which is a unique identifier for each product, number of attempts 212 which refers to how many successful auctions this player has bid for this product ID 210, number of bids/auction 214 referring to the average number of bids placed for each successful auction for this product ID 210, and bid frequency value 216 which is a value indicating the player interest in the product ID 210. It is a value assigned by taking the number of attempts and bids overall to determine how often the player bids on a particular product ID and how many bids they will place in each successful auction.

The offer creation logic 66 program now analyzes the previous exchange information 200 including at 218 Exchange Number 1 in which the program compares the original value of the product ID with the new value 1 of the product ID.

Also analyzed is the success of the exchange with a “Yes” or “No” flag which is appropriately recorded at 220.

Moreover, at 222 as seen by Exchange Number 2, the program compares the original value of the product ID with the new value 2 of the product ID.

The success of the exchange defined as a “Yes” or “No” flag is appropriately recorded 224.

Records continue appropriately until there is a final exchange where the original value is compared to the final value at 226.

Based upon this information the programs will pass the information 228 to additional logic where customer preferences are identified at 230. After identifying customer preferences the information will be passed at 232 to a routine that will direct processing dependent upon whether or not this is the first exchange 68. In the case where this is the first exchange as shown at 68, a “Yes” condition at 236 prompts the program to query the product database 24 for the initial exchange default value 240 for that product ID 242.

In the case where this is not the first exchange, a “No” flag 244 is set, and the program analyzes the customer preferences to identify an exchange offer 88. The product database 24 is then queried at 82; the first update will flag the original value of the exchange so it is not available in inventory.

Based on customer preferences and history, the program will now query the product database 24 for matching exchange offers. As previously illustrated in this diagram, an initial exchange default product will be allocated as the offer for the first exchange. For subsequent offers, the offer creation logic 66 will attempt to locate the best opportunity as dictated by customer preference and history. The exchange offer 250 will be cataloged containing the product ID 242, the product description 252, the product retail value 254 and the inventory availability 256.

The process continues as the customer and product databases are updated at 124 to reflect the new exchange information and according to availability 92. If the product ID(s) are available a “Yes” condition 264 prompts the program to return the exchange opportunity to the primary 80 or secondary logic 122 programs for processing.

If one or more of the product ID(s) are not available, the exchange is processed through offer creation logic 66 as if it were not the 1st exchange request and the offer creation logic 66 will attempt to identify a new exchange offer based upon the updated values. This process continues until there is an available exchange offer, or the original value equals the new value; a condition for which the inventory will always reflect availability and process the exchange offer to the primary 80 or secondary exchange logic program 122.

Referring to FIG. 5: A simplified example of the operation of the components described in FIG. 4 is presented. In this block diagram, it is assumed that the customer is a returning customer with existing records in the customer database 22. For this example, the customer name 202 is Jane Byer and her ID number 203 is 43217 which may be mapped to a different customer identifier 192 (value not shown). She has participated in several previous bids which are recorded in the previous bid information 196. Her history shows that she has bid on three separate items; namely product ID (PID) 737 which relates to the description of a $100 Visa Card, the product ID (PID) 254 relates to the description of a $100 Wal-Mart Card, the next product ID (PID) 789 relates to the description of a $100 Amazon Card. Although she has only bid on three different items, she has tried multiple times. In the case of the Visa Card she has made 2 total bid attempts, has placed 120 total bids and averages a bid frequency value of 60. Correspondingly for her other auction attempts, the Wal-Mart Card she has made 8 total bid attempts, has placed 384 total bids equating to a bid frequency value of 48; and for the Amazon Card she has made 3 total bid attempts, has placed 145 total bids equating to a bid frequency value of 48.3.

The winning bid information 232 is routed from the communications module 14 (not depicted) to the offer creation logic 66 through the primary 80 or secondary 122 exchange logic programs. An exchange request 68 has been initiated from the online auction system 8 that Jane has the winning bid. With a “Yes” flag 182, the offer creation module 66 now sends a request to the customer set up programs 72 to query 228 the customer database 22. Since Jane already exists, a “No” flag 229 is set which directs the program to access the customer history 82. This program analyzes the winning bid information 232 and compares it to the previous bid information 196 in conjunction with the successful bid information 198 and the previous exchange information 200. Prior to this winning bid, Jane has had 2 prior successful bids for Wal-Mart Cards, product ID 254. Her total bids were 92, so her average bids, or bid frequency value is 46. Jane also had one successful bid for a $100 Visa Card, product ID 737. Her total bids were 51, so her average bid, or bid frequency value is also 51. Jane has just won a $100 Amazon Card, product ID 789. It was her third attempt, but it was her first successful time bidding for an Amazon Card, so her total successful bids is 1, her total bids on this auction is 61, but her bid frequency value is 48.3 because she has had a total of 3 bids, and her successful bid is averaged in with her unsuccessful bids. So although the information contained in the winning bid information 232 reflects 61 bids, since her bid frequency value is 48.3, Jane bid much higher than her normal bidding style for this item.

The program will also look at her previous exchange information 200. Jane won a $100 Visa Card with a bid frequency value of 51. The System previously calculated an exchange offer 226 that consisted of a $50 Wal-Mart Card with a bid frequency value of 23 and a 100 Bid Pack with a bid frequency value of 50. Although Jane had not bid on a 100 Bid Pack, the system administrator may have either assigned a value, or the system itself may be programmed to determine a bid frequency value. The combination of the two products now has a relative value of 73.

In arriving at this combination of products, the program takes into account that Jane most often bids on Wal-Mart Cards, making this product of more value to her. The program also recognizes that Jane's overall bid frequency value is 48, the total number of bids divided by the total bid attempts even though her successful bids have a bid frequency value of 46, Jane loses bids pushing her average bid frequency value to 48. The program correctly surmises with a previous bid frequency value of 48.3 for $100 Amazon cards that offering her a combination of products with a bid frequency value of 73, and by fulfilling Jane's desire for a Wal-Mart Card, while providing her with nearly double her usual per auction bid amount in additional bids, that Jane will see more value in the exchange offer than in her $100 Amazon Card.

If this were the first exchange offer shown at 68, the program would query 82 the product database 24 for the initial exchange default product 240 associated with her winning bid 232 as an initial starting point for the exchange process. In checking the offer availability at 92, if the product is not available, the program would attempt to analyze the loop back through the series to ID customer preferences 230 and ID an offer 88 to define an appropriate offer. If the product were available, the process would proceed with a “yes” flag 264.

In analyzing Jane's preferences, the program takes into account that the new winning bid 232, carries a higher bid frequency value of 61 vs. the previous Amazon card value of 48. However, tolerances programmed in the logic will test the elasticity of her desire for the more valuable Wal-Mart Card with an exchange offer 250 once again consisting of the Wal-Mart $50 Card and 00 a 100 Bid Pack. The relative value of this combination is 73. If Jane accepts this offer, the system will rely on Jane's perceived value of the Wal-Mart Card in future offers.

Having identified the offer 88, the program will now query 82 the product database 24 at 258. With the combination of product ID 242, and inventory availability 256 the program determines that the Wal-Mart Card is on record 244. Inventory is available 246. The program determines that the 100 Bid Pack is available 270. The program will now associate the corresponding product retail values found in 254 for display. Once cataloged 250 a “yes” flag 254 is set and the program will update the customer and product database 124. The customer history is accessed at 82 so that the offer can update the previous exchange information 200 with the new exchange offer 250. The product database 24 is updated to flag the offered product so it will not be available from Inventory 256. Jane's current product will remain in inventory until she has made a decision about the exchange. Once updated, the offer is checked once more for availability 92. If it is not available then the program will route the offer through the request system as previously depicted. If the product is available it will be routed to the communications module 14 where it will be routed to the UI presentation module 18 for formatting and layout (not shown) and then for presentation to Jane.

Should Jane accept this exchange, the operator will reduce the hard cost of the cards by 33% while incurring the much lower soft cost of the 100 Bid Pack, which will simply be reused in the system. Jane receives higher perceived value, the operator retains greater margin.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method of offering an alternative purchase option to a successful bidder in an auction, comprising the steps of:
interfacing to an existing auction system;
calculating the value of an item selected by a successful bidder;
relating the value of the item to a plurality of items of perceived equal or greater value;
transmitting to the successful bidder one or more alternative options which may be substituted for the selected item;
substituting an optional item substituted for the selected item that received a winning bid; and,
transmission of the substituted item to the successful bidder.

2. The method of claim 1, wherein the substituted item offered for exchange has perceived value comparable or greater than the item to be exchanged.

3. The method of claim 1, wherein the substituted item offered for exchange includes points or credits towards future auctions.

4. The method of claim 1, wherein the retail price of substituted item is displayed, but the item remains unknown to the successful bidder unless selected.

5. The method of claim 1, and further including a selectable interface to exchange the item selected by a successful bidder for the substituted item including one of a hypertext link and an icon.

6. A computer readable storage medium storing instructions executable by one or more processors, the instructions when executed causing the one or more processors to transmit to a winning bidder a plurality of option items for exchange, each option item having a predetermined value, provide for display of an item available for exchange and a retail price for the item, and provide for display of a selectable exchange item using an interface to exchange an item corresponding to a winning bid with an exchange item.

7. The apparatus and system of claim 6, wherein winning bidder preferences, bidding history, winning bids and exchange history are stored, thus providing a plurality of winning bidder and item specific offerings for exchange.

8. The apparatus of claim 7, wherein the winning bidder is offered additional options for purchase until an item is selected for exchange or the original item is retained.

9. A system for offering an alternative item to a successful bidder in an auction, comprising;
a secondary exchange system interfaced to an existing auction system, said secondary exchange system
a) calculating the value of a selected item to be purchased at the auction,
b) relating the value of said selected item to a plurality of items of perceived equal or greater value to said selected item,
c) transmitting to said successful bidder a list of one or more of said alternative items, thus to establish an alternative purchase option item which may be substituted for said selected item, and
d) substituting for said selected item an alternative item adapted to be selected by said successful bidder, said secondary exchange system arranging for the transmission of the fulfillment of said substituted alternative item to said successful bidder.

10. The system of claim 9, wherein said alternative item has a perceived value comparable or greater than said selected item for which there is to be an exchange.

11. The system of claim 9, wherein said alternative item offered for exchange includes points or credits towards future auctions.

12. The system of claim 9, wherein the retail price of said substituted alternative item is adapted to be displayed to said successful bidder but remains unknown to said successful bidder unless selected by said successful bidder.

13. The system of claim 9, and further including a selectable interface to exchange said alternative item, said selectable interface including one of a hypertext link and an icon.

14. A system for increasing the enjoyment of a successful bidder in an on-line auction, comprising:
an exchange for providing said successful bidder with the option to select an alternative item, thus to prolong the on-line bidding experience.

15. The system of claim 14, wherein said selection is only made after a bidder is successful but before said successful bidder redeems the item won.

16. The system of claim 15, wherein said alternative item is of a value equal to or greater than the item won.

17. The system of claim 14, wherein said alternative item includes points or credits towards a future auction.

18. The system of claim 14, wherein said alternative item is substituted for the item won.
